(19) United States
(12) Patent Application Publication
(10) Pub. No.: US 2013/0257917 A1
(43) Pub. Date: Oct. 3, 2013

(54) DISPLAY DRIVING OPTIMIZATION METHOD AND DISPLAY DRIVER

(71) Applicant: NOVATEK MICROELECTRONICS CORP., Hsinchu (TW)

(72) Inventors: Yu-Hsun Peng, Hsinchu County (TW); Jiun-Ting Chen, Hsinchu City (TW); Yu-Shan Wai, Taipei City (TW); Hsi-Ming Chen, Hsinchu City (TW)

(73) Assignee: NOVATEK MICROELECTRONICS CORP., Hsinchu (TW)

(21) Appl. No.: 13/688,191

(22) Filed: Nov. 28, 2012

(30) Foreign Application Priority Data
Mar. 27, 2012 (TW) 101110610

(51) Int. Cl. G09G 3/20

(52) U.S. Cl. CPC G09G 3/20
USPC 345/690

(57) ABSTRACT

A display driving optimization method and a display driver are provided. The method includes following steps. Previous data and current data of at least a data line of a display panel are estimated to obtain an estimate result. A pre-charge operation or a charge-sharing operation of the data line is enabled or disabled according to the estimation result.

### CROSS-REFERENCE TO RELATED APPLICATION

This application claims the priority benefit of Taiwan application serial no. 101110610, filed on Mar. 27, 2012. The entirety of the above-mentioned patent application is hereby incorporated by reference herein and made a part of this specification.

### BACKGROUND OF THE INVENTION

1. Field of the Invention

The invention relates to a display. Particularly, the invention relates to a display driving optimization method and a display driver.

2. Description of Related Art

Due to advantages of low energy consumption and a smaller size compared to a conventional cathode ray tube (CRT) display, current flat panel displays (for example, liquid crystal displays (LCDs)) have been widely used in various image display devices such as computer systems, mobile phones, personal digital assistants (PDAs), etc. A data voltage can control a gray level of a pixel. A display driver has to write different data voltages into corresponding pixels of the display panel through data lines. In order to decrease power consumption of the display driver, a charge-sharing method is provided.

FIG. 1 is a schematic diagram of a thin film transistor (TFT) LCD 10. The LCD 10 includes an LCD panel 100, a source driver 102, a gate driver 104 and a voltage generator 106. The LCD panel 100 is composed of two substrates, and an LCD layer is filled between the two substrates. A plurality of data lines 108, a plurality of scan lines 110 (or referred to as gate lines) perpendicular to the data lines 108 and a plurality of TFTs 112 are disposed on one substrate, and a common electrode is disposed on another substrate. The voltage generator 106 can provide a common voltage Vcom to the common electrode of the LCD panel 100. The TFTs 112 are distributed on the LCD panel in a matrix. Each of the data lines 108 corresponds to a column on the LCD panel 100, each of the scan lines 110 corresponds to a row on the LCD panel 100, and each of the TFTs 112 corresponds to a pixel. Moreover, a circuit characteristic formed by the two substrates of the LCD panel 100 can be regarded as equivalent capacitors 114.

In FIG. 1, the gate driver 104 sequentially generates gate driving signals VG_1-VG_M to activate the TFTs 112 row by row, so as to update pixel data stored in the equivalent capacitors 114. For example, when the gate driving signal VG_1 activates the TFTs 112 of the first row, the source driver 102 respectively writes data voltages VS_1-VS_N to the pixels of the first row through the corresponding data lines 108 and the TFTs 112. When the gate driving signal VG_2 activates the TFTs 112 of the second row, the source driver 102 respectively writes another set of data voltages VS _1-VS_N to the pixels of the second row through the corresponding data lines 108 and the TFTs 112.

FIG. 2 is a waveform schematic diagram of the data voltage VS_1 of FIG. 1. Referring to FIG. 1 and FIG. 2, when the gate driving signal VG_1 activates the TFTs 112 of the first row, the source driver 102 writes the data voltage VS_1 with a voltage level V1 to the pixel of the first row. When the gate driving signal VG_2 activates the TFTs 112 of the second row, the source driver 102 writes the data voltage VS_1 with a voltage level V2 to the pixel of the second row. If the LCD 10 does not have the charge-sharing function, the source driver 102 has to transit the data voltage VS_1 from the voltage level V1 to the voltage level V2 within a short time. Namely, an output voltage swing of the source driver 102 is a voltage difference 201 shown in FIG. 2.

In the conventional charge-sharing method, before the source driver 102 outputs the data voltages of a next scan line, the adjacent data lines are first short-circuited to reduce the power consumption of the display driver. For example, when the gate driving signal VG_2 activates the TFTs 112 of the second row, the source driver 102 first short-circuits the data line 108 used for transmitting the data voltage VS_1 with the data line 108 used for transmitting the data voltage VS_2. Here, it is assumed that a voltage level of the data voltage VS_1 after the short-circuit operation is V3. After the charge-sharing operation is completed, the source driver 102 cuts off the short circuit connection between the adjacent data lines , and outputs the data voltages of the next scan line (for example, the scan line of the second row). Since the LCD 10 has the charge-sharing function, the source driver 102 only transits the data voltage VS_1 from the voltage level V3 to the voltage level V2, as that shown in FIG. 2. Namely, regarding the source driver 102 having the charge-sharing function, the output voltage swing thereof is a voltage difference 202 shown in FIG. 2. Obviously, the voltage difference 202 is smaller than the voltage difference 201. Therefore, under the operation condition of the driving waveform of FIG. 2, the conventional charge-sharing method can reduce the power consumption of the display driver.

However, regardless of the driving waveform, the conventional charge-sharing method keeps performing the aforementioned charge-sharing operation. Under other operation conditions, the conventional charge-sharing method probably increases the power consumption of the display driver. For example, FIG. 3 is another waveform schematic diagram of the data voltage VS_1 of FIG. 1. It is assumed that the data voltages VS_1 of the first row pixel and the second row pixel all have the voltage level V1. Referring to FIG. 1 and FIG. 3, if the LCD 10 does not have the charge-sharing function, the source driver 102 is only required to maintain the data voltage VS_1 to the voltage level V1. If the LCD 10 executes the conventional charge-sharing method, the charge-sharing operation pulls down the data voltage VS_1 to the voltage level V3. After the charge-sharing operation is completed, the source driver 102 has to spend extra power to pull back the data voltage VS_1 from the voltage level V3 to the voltage level V1, as that shown in FIG. 3. Therefore, the conventional charge-sharing method probably increases the power consumption of the display driver since the conventional charge-sharing method has no optimization in allusion to different driving waveforms.

### SUMMARY OF THE INVENTION

The invention is directed to a display driving optimization method and a display driver, which dynamically determines to enable or disable a pre-charge operation or a charge-sharing operation.

An embodiment of the disclosure provides a display driving optimization method including following steps. Previous data and current data of at least one data line of a display panel are estimated to obtain an estimation result. It is determined to enable or disable a pre-charge operation or a charge-sharing operation of the data line according to the estimation result.

Another embodiment of the invention provides a display driver. The display driver includes a data driving unit, a pre-charge or charge-sharing circuit and a detection logic unit. The data driving unit includes at least one data channel for correspondingly coupling to at least one data line of a display panel. The data driving unit transmits previous data to the data line, and receives current data. The pre-charge or charge-sharing circuit is coupled to the data line. The detection logic unit is coupled to the data driving unit and the pre-charge or charge-sharing circuit. The detection logic unit records the previous data and receives the current data. The detection logic unit estimates the previous data and the current data of the data line to obtain an estimation result. The detection logic unit determines to enable or disable the pre-charge or charge-sharing circuit to perform a pre-charge operation or a charge-sharing operation on the data line according to the estimation result.

According to the above descriptions, the previous data and the current data of the display panel are estimated to dynamically determine whether or not to enable (or disable) the pre-charge operation (or the charge-sharing operation) of the display panel. Therefore, the embodiment of the invention can implement optimization in allusion to different driving waveforms.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a thin film transistor (TFT) liquid crystal display (LCD).

FIG. 2 is a waveform schematic diagram of a data voltage VS_1 of FIG. 1.

FIG. 3 is another waveform schematic diagram of a data voltage VS_1 of FIG. 1.

FIG. 4 is a functional block schematic diagram of a display driver according to an embodiment of the invention.

FIG. 5 is a flowchart illustrating a display driving optimization method for the display driver of FIG. 4 according to an embodiment of the invention.

FIG. 6 is a flowchart illustrating a display driving optimization method for the display driver of FIG. 4 according to another embodiment of the invention.

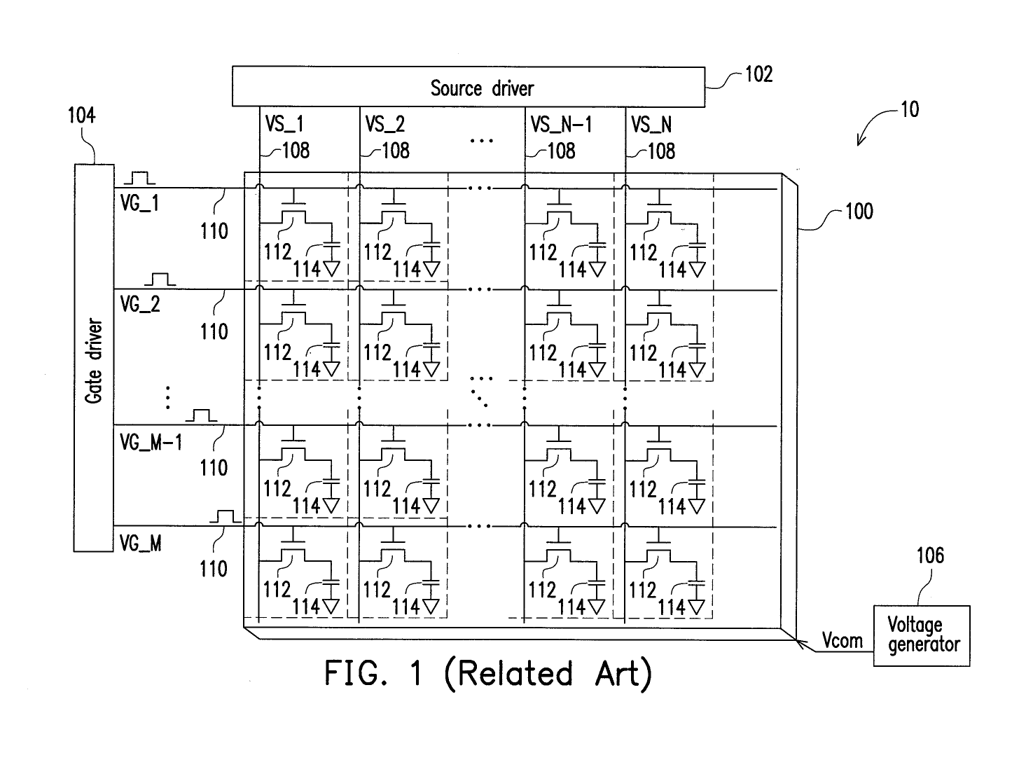

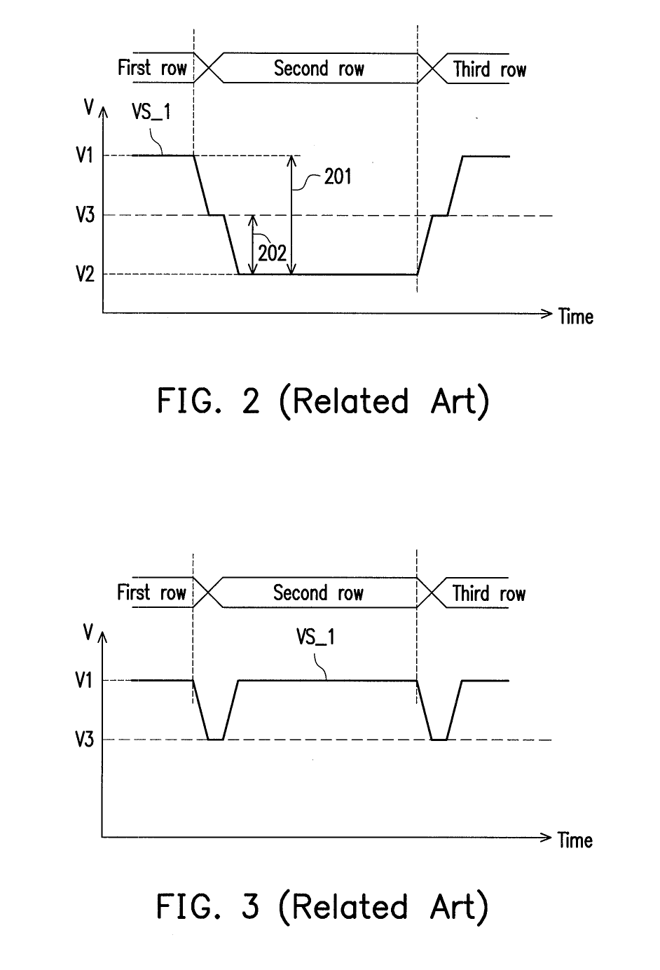

### DETAILED DESCRIPTION OF DISCLOSED EMBODIMENTS

Following exemplary embodiments of the invention can be applied to a flat panel display (for example, a liquid crystal display, etc.). By estimating a difference of two tandem groups of image data, it is dynamically determined whether or not to enable (or disable) a pre-charge operation (or a charge-sharing operation) of a display panel, so as to achieve driving optimization and a powering-saving effect. Embodiments are provided below for descriptions, though the invention is not limited to the provided embodiments, and the provided embodiments can be suitably combined.

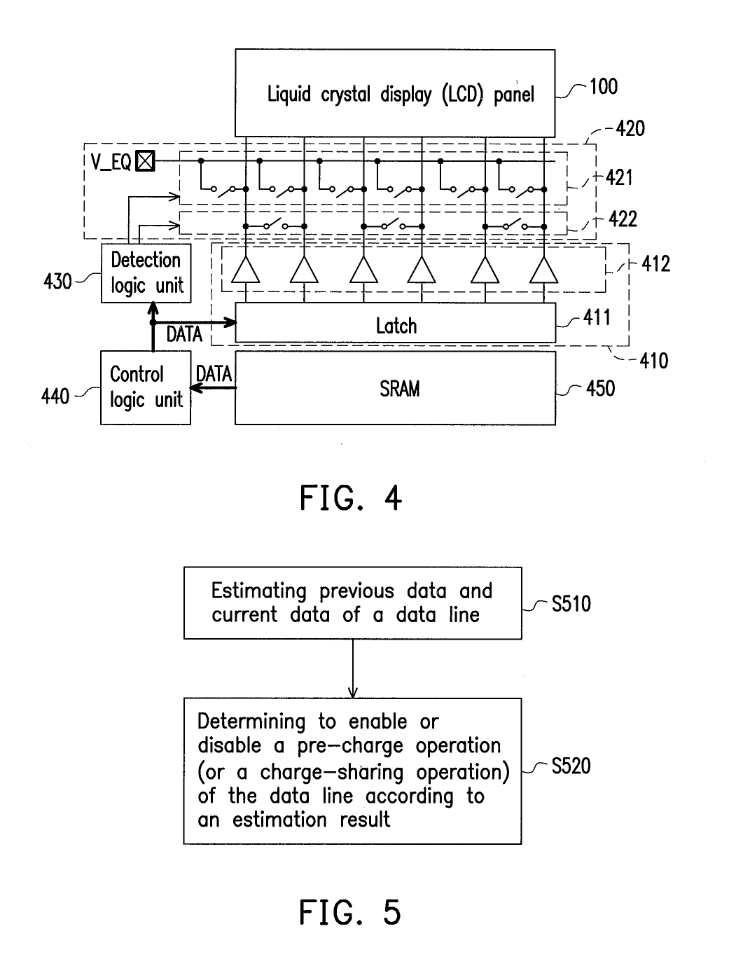

FIG. 4 is a functional block schematic diagram of a display driver according to an embodiment of the invention. The display driver includes a data driving unit 410, a pre-charge or charge-sharing circuit 420 and a detection logic unit 430. The data driving unit 410 includes at least one data channel. The at least one data channel is correspondingly coupled to at least one data line of a display panel 100. A control logic unit 440 is also referred to as a timing controller. The control logic unit 440 extracts display data DATA from a static random access memory (SRAM) 450, and outputs the display data DATA to the data driving unit 410 and the detection logic unit 430. The data driving unit 410 transmits latched previous data (old display data) to the data lines of the display panel 100, and receives a next batch of display data (or referred to as current data).

In the present embodiment, the data driving unit 410 includes a latch 411 and an output buffer 412. The latch 411 is controlled by the control logic unit 440. Under control of the control logic unit 440, the latch 411 receives and latches the display data DATA output by the control logic unit 440, and transmits the latched display data DATA to the data lines of the display panel 100 through the output buffer 412. In some embodiments, the latch 411 or the output buffer 412 can convert digital display data into analog display data.

The pre-charge or charge-sharing circuit 420 is coupled to the data lines of the display panel 100. The pre-charge or charge-sharing circuit 420 can perform a pre-charge operation and/or a charge-sharing operation to the data lines of the display panel 100. In the present embodiment, the pre-charge or charge-sharing circuit 420 includes a pre-charge circuit 421 and a charge-sharing circuit 422. The pre-charge circuit 421, the charge-sharing circuit 422 and the data driving unit 410 are all controlled by the control logic unit 440.

The charge-sharing circuit 422 can perform the charge-sharing operation. For example, before the data driving unit 410 outputs the data voltage of a next scan line, the charge-sharing circuit 422 first short-circuits the adjacent data lines to reduce power consumption of the data driving unit 410. After the charge-sharing operation is completed, the charge-sharing circuit 422 cuts off the short circuit connection between the adjacent data lines, and then the data driving unit 410 outputs the data voltages of the next scan line.

The pre-charge circuit 421 can perform the pre-charge operation. The pre-charge circuit 421 is coupled to a reference voltage source for receiving a pre-charge voltage V_EQ. Before the data driving unit 410 outputs the data voltages of the next scan line, the pre-charge circuit 421 outputs the pre-charge voltage V_EQ to the data lines of the display panel 100, so as to reduce the power consumption of the data driving unit 410. After the pre-charge operation is completed, electrical paths between the pre-charge circuit 421 and the data lines are cut off, and then the data driving unit 410 outputs the data voltages of the next scan line.

In the present embodiment, although the pre-charge or charge-sharing circuit 420 includes both of the pre-charge circuit 421 and the charge-sharing circuit 422, the invention is not limited thereto. For example, the pre-charge circuit 421 and the charge-sharing circuit 422 can be omitted according to an actual design requirement.

The detection logic unit 430 is coupled to the data driving unit 410 and the pre-charge or charge-sharing circuit 420. The control logic unit 440 outputs the display data DATA to the detection logic unit 430. The detection logic unit 430 records the previous data and receives the current data.

FIG. 5 is a flowchart illustrating a display driving optimization method for the display driver of FIG. 4 according to an embodiment of the invention. Referring to FIG. 4 and FIG. 5, the detection logic unit 430 executes a step S10 to estimate the previous data and the current data of the data line to obtain an estimation result. The detection logic unit 430 executes a step S20, and determines to enable or disable the pre-charge operation (or the charge-sharing operation) performed on the data line by the pre-charge or charge-sharing circuit 420 according to the estimation result. For example, if the estimation result shows that an image displayed by the display panel 100 is a static image, the detection logic unit 430 disables the pre-charge circuit 421 and the charge-sharing circuit 422.

The aforementioned “previous data” and the “current data” can be different pixel data of a same data line, or can be different pixel data of a plurality of data lines. In some embodiments, when the previous data and the current data are different pixel data of the same data line, in the step S510, a difference between the previous data and the current data is compared, and the difference is taken as the estimation result. For example, a first data line of the display panel 100 is taken as an example, and it is assumed that the display data transmitted to the pixel of the first scan line by the first data line is the previous data, and the display data transmitted to the pixel of the second scan line by the first data line is the current data. If a difference between the previous data and the current data of the first data line is smaller than a predetermined threshold, i.e. gray levels of the previous data and the current data are rather close, the detection logic unit 430 can disable the pre-charge circuit 421 and/or the charge-sharing circuit 422.

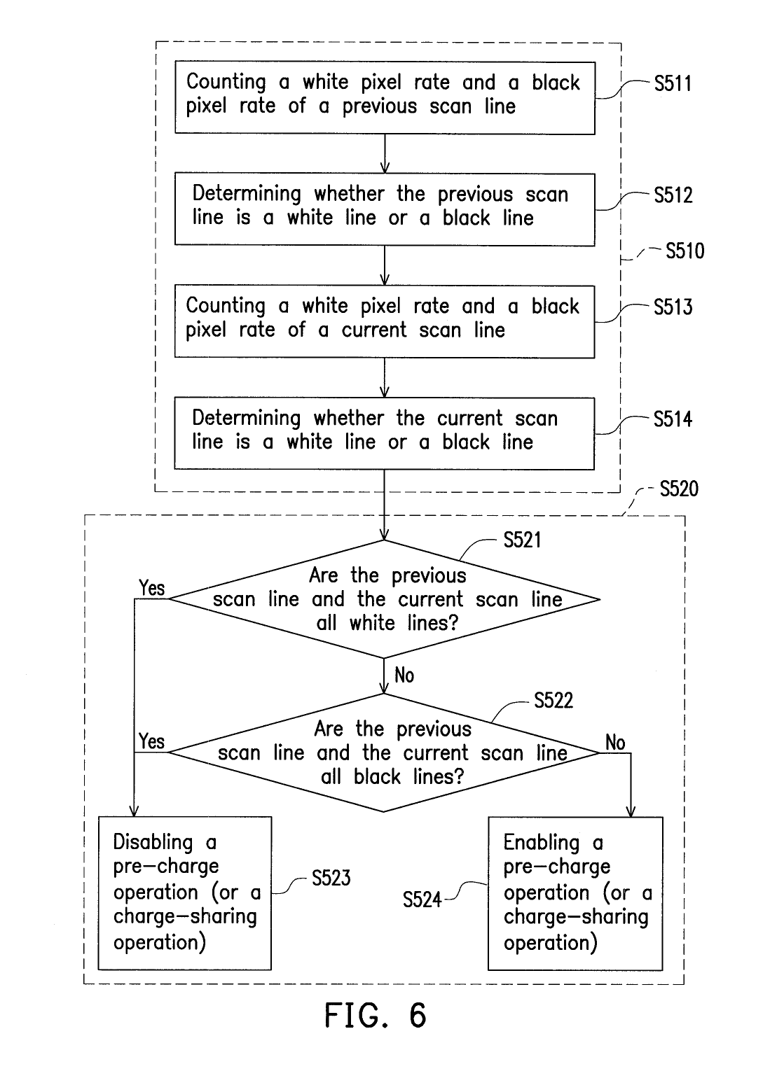

In another embodiment, the previous data can be a plurality of pixel data on a previous scan line, and the current data can be a plurality of pixel data on a current scan line. FIG. 6 is a flowchart illustrating a display driving optimization method for the display driver of FIG. 4 according to another embodiment of the invention. Related descriptions of FIG. 5 can be referred for the embodiment of FIG. 6. Referring to FIG. 4 and FIG. 6, in the present embodiment, the step S510 includes a plurality of sub steps S511-S514. First, the detection logic unit 430 executes the step S511 to count a plurality of pixel data on the previous scan line (for example, the first scan line of the display panel 100), so as to obtain a white pixel rate and a black pixel rate of the previous scan line.

In the step S511, the detection logic unit 430 inspects each pixel data of the previous scan line. If data of a certain pixel of the previous scan line is greater than a white pixel limit D_white_limit, such pixel is defined as a white pixel. If data of a certain pixel of the previous scan line is smaller than a black pixel limit D_black_limit, such pixel is defined as a black pixel. If data of a certain pixel of the previous scan line is between the black pixel limit D_black_limit and the white pixel limit D_white limit, such pixel is defined as a gray pixel. Namely, the detection logic unit 430 defines the pixel having the pixel data greater than the white pixel limit D_white_limit in a plurality of pixels of the previous scan line as the white pixel, and defines the pixel having the pixel data smaller than the black pixel limit D_black_limit as the black pixel. The detection logic unit 430 counts the number of the white pixels on the previous scan line to obtain the white pixel rate of the previous scan line. For example, if the previous scan line has x pixels, and y pixels in the x pixels are white pixels, the white pixel rate of the previous scan line is y/x. Similarly, the detection logic unit 430 counts the number of the black pixels on the previous scan line to obtain the black pixel rate of the previous scan line.

After the step S511 is completed, the detection logic unit 430 executes the step S512. In the step S512, the detection logic unit 430 determines whether the previous scan line is a white line or a black line. If the white pixel rate of the previous scan line is greater than a white line limit R_white_limit, the previous scan line is defined as the white line. If the black pixel rate of the previous scan line is greater than a black line limit R_black_limit, the previous scan line is defined as the black line. If the white pixel rate of the previous scan line is smaller than the white line limit R_white_limit and the black pixel rate is smaller than the black line limit R_black_limit, the previous scan line is defined as a gray line. The white line limit R_white_limit and the black line limit R_black_limit can be determined according to an actual design requirement of the product.

After the step S512 is completed, the detection logic unit 430 executes the step S513. In the step S513, the detection logic unit 430 counts the pixel data on the current scan line (for example, the second scan line of the display panel 100) to obtain a white pixel rate and a black pixel rate of the current scan line. Implementation details of the step S513 can be deduced according to related descriptions of the step S511. After the step S513 is completed, the detection logic unit 430 executes the step S514. In the step S514, the detection logic unit 430 determines whether the current scan line is a white line or a black line. If the white pixel rate of the current scan line is greater than the white line limit R_white_limit, the current scan line is defined as the white line. If the black pixel rate of the current scan line is greater than the black line limit R_black_limit, the current scan line is defined as the black line.

In the embodiment of FIG. 6, the step S520 includes a plurality of sub steps S521-S524. First, the detection logic unit 430 executes the step S521 to determined whether the previous scan line and the current scan line are all white lines. If the previous scan line and the current scan line are all white lines, the detection logic unit 430 executes the step S523 to disable the pre-charge operation (or the charge-sharing operation) of the data line of the display panel 100, i.e. disable the pre-charge circuit 421 and/or the charge-sharing circuit 422. If a determination result of the step S521 is negative, the detection logic unit 430 executes the step S522 to determine whether the previous scan line and the current scan line are all black lines. If the previous scan line and the current scan line are all black lines, the detection logic unit 430 executes the step S523 to disable the pre-charge operation (or the charge-sharing operation) of the data line of the display panel 100.

If a determination result of the step S522 is negative, the detection logic unit 430 executes the step S524 to enable the pre-charge operation (and/or the charge-sharing operation) of the data line of the display panel 100, i.e. enable the pre-charge circuit 421 and/or the charge-sharing circuit 422. For example, if the previous scan line is the white line and the current scan line is the black line, the detection logic unit 430 enables the pre-charge operation (or the charge-sharing operation) of the data line of the display panel 100. For another example, if the previous scan line is the black line and the current scan line is the white line, the detection logic unit 430 enables the pre-charge operation (or the charge-sharing operation) of the data line of the display panel 100.

Implementations of the invention are not limited to the aforementioned embodiments. For example, the previous data can be a plurality of pixel data of a previous scan line group (a plurality of previous scan lines), and the current data can be a plurality of pixel data of a current scan line group (a plurality of current scan lines). Therefore, the step S510 may include following steps. The detection logic unit 430 counts the pixel data on the previous scan line group to obtain a white pixel rate and a black pixel rate of the previous scan line group. The detection logic unit 430 counts the pixel data on the current scan line group to obtain a white pixel rate and a black pixel rate of the current scan line group. Implementation details of analysing the white pixel rate and the black pixel rate of the previous scan line group can be deduced according to related descriptions of the step S511 of FIG. 6. Implementation details of analysing the white pixel rate and the black pixel rate of the current scan line group can be deduced according to related descriptions of the step S513 of FIG. 6. If the white pixel rate of the previous scan line group is greater than the white line limit R_white_limit, the previous scan line group is defined as a white line group. If the black pixel rate of the previous scan line group is greater than the black line limit R_black_limit, the previous scan line group is defined as a black line group. If the white pixel rate of the current scan line group is greater than the white line limit R_white_limit, the current scan line group is defined as the white line group. If the black pixel rate of the current scan line group is greater than the black line limit R_black_limit, the current scan line group is defined as the black line group.

In the present embodiment, the step S520 includes following steps. The detection logic unit 430 compares the previous scan line group and the current scan line group, and determines to enable or disable the pre-charge operation (or the charge-sharing operation) performed on the data line of the display panel 100 by the pre-charge or charge-sharing circuit 420. For example, if the previous scan line group and the current scan line group are all white line groups, the detection logic unit 430 disables the pre-charge operation (or the charge-sharing operation) of the data line of the display panel 100. If the previous scan line group and the current scan line group are all black line groups, the detection logic unit 430 disables the pre-charge operation (or the charge-sharing operation) of the data line of the display panel 100. If the previous scan line group is the white line group and the current scan line group is the black line group, the detection logic unit 430 enables the pre-charge operation (or the charge-sharing operation) of the data line of the display panel 100. If the previous scan line group is the black line group and the current scan line group is the white line group, the detection logic unit 430 enables the pre-charge operation (or the charge-sharing operation) of the data line of the display panel 100.

In other embodiments, the previous data can be a plurality of pixel data in a previous frame, and the current data can be a plurality of pixel data in a current frame. The previous frame can be an n^{th} frame, and the current frame can be an (n+1)^{th} frame. In this way, the step S510 may include following steps. The detection logic unit 430 counts the pixel data in the previous frame to obtain a white pixel rate and a black pixel rate of the previous frame. The detection logic unit 430 counts the pixel data in the current frame to obtain a white pixel rate and a black pixel rate of the current frame. Implementation details of analysing the white pixel rate and the black pixel rate of the previous frame can be deduced according to related descriptions of the step S511 of FIG. 6. Implementation details of analysing the white pixel rate and the black pixel rate of the current frame can be deduced according to related descriptions of the step S513 of FIG. 6. If the white pixel rate of the previous frame is greater than the white line limit R_white_limit, the previous frame is defined as a white frame. If the black pixel rate of the previous frame is greater than the black line limit R_black_limit, the previous frame is defined as a black frame. If the white pixel rate of the current frame is greater than the white line limit R_white_limit, the current frame is defined as the white frame. If the black pixel rate of the current frame is greater than the black line limit R_black_limit, the current frame is defined as the black frame.

In the present embodiment, the step S520 includes following steps. The detection logic unit 430 compares the previous frame and the current frame, and determines to enable or disable the pre-charge operation (or the charge-sharing operation) performed on the data line of the display panel 100 by the pre-charge or charge-sharing circuit 420. For example, if the previous frame and the current frame are all white frames, the detection logic unit 430 disables the pre-charge operation (or the charge-sharing operation) of the data line of the display panel 100. If the previous frame and the current frame are all black frames, the detection logic unit 430 disables the pre-charge operation (or the charge-sharing operation) of the data line of the display panel 100. If the previous frame is the white frame and the current frame is the black frame, the detection logic unit 430 enables the pre-charge operation (or the charge-sharing operation) of the data line of the display panel 100. If the previous frame is the black frame and the current frame is the white frame, the detection logic unit 430 enables the pre-charge operation (or the charge-sharing operation) of the data line of the display panel 100.

In summary, in the display driving optimization method and the display driver of the invention, the previous data and the current data of the display panel are estimated to dynamically determine whether or not to enable (or disable) the pre-charge operation (or the charge-sharing operation) of the display panel. Therefore, the embodiment of the invention can implement optimization in allusion to different driving waveforms, so as to achieve an effect of saving power consumption.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display driving optimization method, comprising:
estimating previous data and current data of at least one data line of a display panel to obtain an estimation result; and
determining to enable or disable a pre-charge operation or a charge-sharing operation of the data line according to the estimation result.

2. The display driving optimization method as claimed in claim 1, wherein the previous data and the current data are different pixel data of a same data line, and the step of estimating the previous data and the current data comprises:
comparing a difference between the previous data and the current data, and taking the difference as the estimation result.

3. The display driving optimization method as claimed in claim 1, wherein the previous data is a plurality of pixel data on a previous scan line, and the current data is a plurality of pixel data on a current scan line.

4. The display driving optimization method as claimed in claim 3, wherein the step of estimating the previous data and the current data comprises:
counting the pixel data on the previous scan line to obtain a white pixel rate and a black pixel rate of the previous scan line;
defining the previous scan line as a white line when the white pixel rate on the previous scan line is greater than a white line limit;
defining the previous scan line as a black line when the black pixel rate on the previous scan line is greater than a black line limit;
counting the pixel data on the current scan line to obtain a white pixel rate and a black pixel rate of the current scan line;
defining the current scan line as a white line when the white pixel rate on the current scan line is greater than the white line limit; and
defining the current scan line as a black line when the black pixel rate on the current scan line is greater than the black line limit.

5. The display driving optimization method as claimed in claim 4, wherein the step of counting the pixel data on the previous scan line comprises:
defining pixels having pixel data greater than a white pixel limit in a plurality of pixels on the previous scan line as white pixels;
defining pixels having pixel data smaller than a black pixel limit in the pixels on the previous scan line as black pixels;
counting a number of the white pixels on the previous scan line to obtain the white pixel rate of the previous scan line; and
counting a number of the black pixels on the previous scan line to obtain the black pixel rate of the previous scan line.

6. The display driving optimization method as claimed in claim 4, wherein the step of determining to enable or disable the pre-charge operation or the charge-sharing operation of the data line comprises:
disabling the pre-charge operation or the charge-sharing operation of the data line when the previous scan line and the current scan line are all white lines;
disabling the pre-charge operation or the charge-sharing operation of the data line when the previous scan line and the current scan line are all black lines;
enabling the pre-charge operation or the charge-sharing operation of the data line when the previous scan line is a white line and the current scan line is a black line; and
enabling the pre-charge operation or the charge-sharing operation of the data line when the previous scan line is a black line and the current scan line is a white line.

7. The display driving optimization method as claimed in claim 1, wherein the previous data is a plurality of pixel data on a previous scan line group, and the current data is a plurality of pixel data on a current scan line group.

8. The display driving optimization method as claimed in claim 7, wherein the step of estimating the previous data and the current data comprises:
counting the pixel data on the previous scan line group to obtain a white pixel rate and a black pixel rate of the previous scan line group;
defining the previous scan line group as a white line group when the white pixel rate on the previous scan line group is greater than a white line limit;
defining the previous scan line group as a black line group when the black pixel rate on the previous scan line group is greater than a black line limit;
counting the pixel data on the current scan line group to obtain a white pixel rate and a black pixel rate of the current scan line group;
defining the current scan line group as a white line group when the white pixel rate on the current scan line group is greater than the white line limit; and
defining the current scan line group as a black line group when the black pixel rate on the current scan line group is greater than the black line limit.

9. The display driving optimization method as claimed in claim 8, wherein the step of counting the pixel data on the previous scan line comprises:
defining pixels having pixel data greater than a white pixel limit in a plurality of pixels on the previous scan line group as white pixels;
defining pixels having pixel data smaller than a black pixel limit in the pixels on the previous scan line group as black pixels;
counting a number of the white pixels on the previous scan line group to obtain the white pixel rate of the previous scan line group; and
counting a number of the black pixels on the previous scan line group to obtain the black pixel rate of the previous scan line group.

10. The display driving optimization method as claimed in claim 8, wherein the step of determining to enable or disable the pre-charge operation or the charge-sharing operation of the data line comprises:
disabling the pre-charge operation or the charge-sharing operation of the data line when the previous scan line group and the current scan line group are all white line groups;
disabling the pre-charge operation or the charge-sharing operation of the data line when the previous scan line group and the current scan line group are all black line groups;
enabling the pre-charge operation or the charge-sharing operation of the data line when the previous scan line group is a white line group and the current scan line group is a black line group; and
enabling the pre-charge operation or the charge-sharing operation of the data line when the previous scan line group is a black line group and the current scan line group is a white line group.

11. The display driving optimization method as claimed in claim 1, wherein the previous data is a plurality of pixel data in a previous frame, and the current data is a plurality of pixel data in a current frame.

12. The display driving optimization method as claimed in claim 11, wherein the step of estimating the previous data and the current data comprises:
counting the pixel data in the previous frame to obtain a white pixel rate and a black pixel rate of the previous frame;
defining the previous frame as a white frame when the white pixel rate of the previous frame is greater than a white line limit;
defining the previous frame as a black frame when the black pixel rate of the previous frame is greater than a black line limit;
counting the pixel data in the current frame to obtain a white pixel rate and a black pixel rate of the current frame;
defining the current frame as a white frame when the white pixel rate of the current frame is greater than the white line limit; and
defining the current frame as a black frame when the black pixel rate of the current frame is greater than the black line limit

13. The display driving optimization method as claimed in claim 12, wherein the step of counting the pixel data in the previous frame comprises:
defining pixels having pixel data greater than a white pixel limit in a plurality of pixels of the previous frame as white pixels;
defining pixels having pixel data smaller than a black pixel limit in the pixels of the previous frame as black pixels;
counting a number of the white pixels of the previous frame to obtain the white pixel rate of the previous frame; and
counting a number of the black pixels of the previous frame to obtain the black pixel rate of the previous frame.

14. The display driving optimization method as claimed in claim 12, wherein the step of determining to enable or disable the pre-charge operation or the charge-sharing operation of the data line comprises:
disabling the pre-charge operation or the charge-sharing operation of the data line when the previous frame and the current frame are all white frames;
disabling the pre-charge operation or the charge-sharing operation of the data line when the previous frame and the current frame are all black frames;
enabling the pre-charge operation or the charge-sharing operation of the data line when the previous frame is a white frame and the current frame is a black frame; and
enabling the pre-charge operation or the charge-sharing operation of the data line group when the previous frame is a black frame and the current frame is a white frame.

15. A display driver, comprising:
a data driving unit, comprising at least one data channel for correspondingly coupling to at least one data line of a display panel, wherein the data driving unit transmits previous data to the data line, and receives current data;
a pre-charge or charge-sharing circuit, coupled to the data line; and
a detection logic unit, coupled to the data driving unit and the pre-charge or charge-sharing circuit, wherein the detection logic unit records the previous data and receives the current data; the detection logic unit estimates the previous data and the current data of the data line to obtain an estimation result; and the detection logic unit determines to enable or disable the pre-charge or charge-sharing circuit to perform a pre-charge operation or a charge-sharing operation on the data line according to the estimation result.

16. The display driver as claimed in claim 15, wherein the previous data and the current data are different pixel data of a same data line, and the detection logic unit compares a difference between the previous data and the current data, and takes the difference as the estimation result.

17. The display driver as claimed in claim 15, wherein the previous data is a plurality of pixel data on a previous scan line of the display panel, and the current data is a plurality of pixel data on a current scan line of the display panel.

18. The display driver as claimed in claim 17, wherein the detection logic unit counts the pixel data on the previous scan line to obtain a white pixel rate and a black pixel rate of the previous scan line, defines the previous scan line as a white line when the white pixel rate on the previous scan line is greater than a white line limit, and defines the previous scan line as a black line when the black pixel rate on the previous scan line is greater than a black line limit; and the detection logic unit counts the pixel data on the current scan line to obtain a white pixel rate and a black pixel rate of the current scan line, defines the current scan line as a white line when the white pixel rate on the current scan line is greater than the white line limit, and defines the current scan line as a black line when the black pixel rate on the current scan line is greater than the black line limit.

19. The display driver as claimed in claim 18, wherein the detection logic unit defines pixels having pixel data greater than a white pixel limit in a plurality of pixels on the previous scan line as white pixels, and defines pixels having pixel data smaller than a black pixel limit in the pixels on the previous scan line as black pixels; and the detection logic unit counts a number of the white pixels on the previous scan line to obtain the white pixel rate of the previous scan line, and counts a number of the black pixels on the previous scan line to obtain the black pixel rate of the previous scan line.

20. The display driver as claimed in claim 18, wherein the detection logic unit disables the pre-charge operation or the charge-sharing operation performed on the data line by the pre-charge or charge-sharing circuit when the previous scan line and the current scan line are all white lines; the detection logic unit disables the pre-charge operation or the charge-sharing operation performed on the data line by the pre-charge or charge-sharing circuit when the previous scan line and the current scan line are all black lines; the detection logic unit enables the pre-charge operation or the charge-sharing operation performed on the data line by the pre-charge or charge-sharing circuit when the previous scan line is a white line and the current scan line is a black line; and the detection logic unit enables the pre-charge operation or the charge-sharing operation performed on the data line by the pre-charge or charge-sharing circuit when the previous scan line is a black line and the current scan line is a white line.

21. The display driver as claimed in claim 15, wherein the previous data is a plurality of pixel data on a previous scan line group of the display panel, and the current data is a plurality of pixel data on a current scan line group of the display panel.

22. The display driver as claimed in claim 21, wherein the detection logic unit counts the pixel data on the previous scan line group to obtain a white pixel rate and a black pixel rate of the previous scan line group, defines the previous scan line group as a white line group when the white pixel rate on the previous scan line group is greater than a white line limit, and defines the previous scan line group as a black line group when the black pixel rate on the previous scan line group is greater than a black line limit; and the detection logic unit counts the pixel data on the current scan line group to obtain a white pixel rate and a black pixel rate of the current scan line group, defines the current scan line group as a white line group when the white pixel rate on the current scan line group is greater than the white line limit, and defines the current scan line group as a black line group when the black pixel rate on the current scan line group is greater than the black line limit.

23. The display driver as claimed in claim 22, wherein the detection logic unit defines pixels having pixel data greater than a white pixel limit in a plurality of pixels on the previous scan line group as white pixels, and defines pixels having pixel data smaller than a black pixel limit in the pixels on the previous scan line group as black pixels; and the detection logic unit counts a number of the white pixels on the previous scan line group to obtain the white pixel rate of the previous scan line group, and counts a number of the black pixels on the previous scan line group to obtain the black pixel rate of the previous scan line group.

24. The display driver as claimed in claim 22, wherein the detection logic unit disables the pre-charge operation or the charge-sharing operation performed on the data line by the pre-charge or charge-sharing circuit when the previous scan line group and the current scan line group are all white line groups; the detection logic unit disables the pre-charge operation or the charge-sharing operation performed on the data line by the pre-charge or charge-sharing circuit when the previous scan line group and the current scan line group are all black line groups; the detection logic unit enables the pre-charge operation or the charge-sharing operation performed on the data line by the pre-charge or charge-sharing circuit when the previous scan line group is a white line group and the current scan line group is a black line group; and the detection logic unit enables the pre-charge operation or the charge-sharing operation performed on the data line by the pre-charge or charge-sharing circuit when the previous scan line group is a black line group and the current scan line group is a white line group.

25. The display driver as claimed in claim 15, wherein the previous data is a plurality of pixel data in a previous frame, and the current data is a plurality of pixel data in a current frame.

26. The display driver as claimed in claim 25, wherein the detection logic unit counts the pixel data in the previous frame to obtain a white pixel rate and a black pixel rate of the previous frame, defines the previous frame as a white frame when the white pixel rate of the previous frame is greater than a white line limit, and defines the previous frame as a black frame when the black pixel rate of the previous frame is greater than a black line limit; and the detection logic unit counts the pixel data in the current frame to obtain a white pixel rate and a black pixel rate of the current frame, defines the current frame as a white frame when the white pixel rate of the current frame is greater than the white line limit, and defines the current frame as a black frame when the black pixel rate of the current frame is greater than the black line limit.

27. The display driver as claimed in claim 26, wherein the detection logic unit defines pixels having pixel data greater than a white pixel limit in a plurality of pixels of the previous frame as white pixels, and defines pixels having pixel data smaller than a black pixel limit in the pixels of the previous frame as black pixels; and the detection logic unit counts a number of the white pixels of the previous frame to obtain the white pixel rate of the previous frame, and counts a number of the black pixels of the previous frame to obtain the black pixel rate of the previous frame.

28. The display driver as claimed in claim 26, wherein the detection logic unit disables the pre-charge operation or the charge-sharing operation performed on the data line by the pre-charge or charge-sharing circuit when the previous frame and the current frame are all white frames; the detection logic unit disables the pre-charge operation or the charge-sharing operation performed on the data line by the pre-charge or charge-sharing circuit when the previous frame and the current frame are all black line groups; the detection logic unit enables the pre-charge operation or the charge-sharing operation performed on the data line by the pre-charge or charge-sharing circuit when the previous frame is a white frame and the current frame is a black frame; and the detection logic unit enables the pre-charge operation or the charge-sharing operation performed on the data line by the pre-charge or charge-sharing circuit when the previous frame is a black frame and the current frame is a white frame.
